(19) United States
(12) Patent Application Publication
(10) Pub. No.: US 2006/0183814 A1
(43) Pub. Date: Aug. 17, 2006

(54) Emulsion ink

(75) Inventors: John Christopher Adams, Clackmannanshire (GB); Keisuke Asada, Miyagi-Prefecture (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignees: G R Advanced Materials Ltd.; Tohoku Ricoh Co., Ltd.

(21) Appl. No.: 11/334,985

(22) Filed: Jan. 19, 2006

(30) Foreign Application Priority Data
Jan. 19, 2005 (GB) 0501114.3

(51) Int. Cl. C03C 17/00

(52) U.S. Cl. 523/160; 524/801

(57) ABSTRACT

The water-in-oil emulsion ink of the invention includes a water phase dispersed within an oil phase, wherein the oil phase comprises a polymeric emulsifier, and wherein the polymeric emulsifier comprises an ABA block copolymer comprising blocks of a polymer A and at least one block of a polymer B, wherein one of polymer A or B is derived from one or more oil-soluble monocarboxylic acid monomers, and the other of polymer A or B is a water-soluble polyalkylene glycol.

### FIELD OF THE INVENTION

The present invention relates to water-in-oil emulsion inks for use in the digital duplicator printing process, and in particular to water-in-oil emulsion inks which exhibit enhanced stability to phase separation.

### BACKGROUND TO THE INVENTION

The digital duplicator printing process is a form of stencil printing. The stencil comprises a thermosensitive film with a porous backing layer. Typically the stencil is a laminate of film and porous tissue paper. Image voids are created in the stencil by selectively melting areas of the film component. This is achieved by moving the stencil across the surface of a thermal printing head where an array of point heaters is controlled by a print head driver to provide a pulse of heat for each void. The printing operation is a rotary printing process in which the stencil is mounted on the circumference of a printing drum and fixed at its leading edge by a clamp. The printing drum contains printing ink and has a mesh screen circumference. Prints are made by passing sheets of paper under the drum in point contact as it rotates, ink being forced through the screens and stencil on to the paper. Typically the processes of imaging the stencil and printing are integrated into a single operation so that whilst the stencil is being imaged, the used stencil from the previous printing run is being wound off the drum into a dump box. The leading edge of the new stencil is then fed into the open clamp on the printing drum and wound on to be ready for the next printing run.

It is well known to use water-in-oil emulsion inks for this printing process. Inks may contain pigment in the oil phase, as for example described in EP-A-0778324, or pigment in the water phase as described in US-A-2839412. The ink formulations which are described therein and also those from other prior art developments are intended to achieve a degree of stability necessary to enable use as commercial products.

Within the parameters which define the stability of emulsion inks an important consideration is the absence of phase separation during storage and use of the ink. Premature phase separation may be evidenced by the emergence of clear oil (oil phase pigmentation) or coloured aqueous liquid (water phase pigmentation) before the bulk of emulsion ink when the container of ink is opened after storage. Whilst this may initially be a matter of aesthetic concern, the continuation of this deterioration will ultimately have a detrimental effect on the printing process.

Whilst the above problems and their solutions are well known for emulsion inks in general, the Applicants have recently encountered very specific problems caused by phase separation occurring when emulsion inks are used in digital duplicators. These problems have not previously been identified or addressed.

In detail, after completion of a digital duplicator printing run, the used stencil is retained on the surface of the printing drum with ink entrained within the porous support component of the stencil. The Applicants have now discovered that it is possible for this ink to undergo a process of separation wherein the liberated oil phase component moves up the stencil to the point where it is clamped to the printing drum. Once this point is reached, there is a high probability that the stencil will become stuck to the clamp. When this occurs the machine is unable to eject the used stencil at the start of the next printing run. Further operation of the digital duplicator is thus prevented until a corrective service operation is carried out. It has been found that the tendency for oil separation to occur becomes more pronounced as the viscosity of the oil phase is decreased. The evolution of the digital duplicating process to use stencil masters with ever smaller pixel voids and porous coatings to replace porous tissue paper supports has required the development of inks with progressively lower viscosities for the oil phase. As a result, a point has been reached where it is necessary to provide a means of achieving a higher stability to phase separation than can be achieved by the prior art.

### SUMMARY OF THE INVENTION

According to a first aspect of the present invention, a water-in-oil emulsion ink comprises a water phase dispersed within an oil phase, wherein the oil phase comprises a polymeric emulsifier, and wherein the polymeric emulsifier comprises an ABA block copolymer comprising blocks of a polymer A and at least one block of a polymer B, wherein one of polymer A or B is derived from oil-soluble monocarboxylic acid monomers, and the other of polymer A or B is a water-soluble polyalkylene glycol. In the context of this invention, a Ablock@ of polymer generally consists of a polymeric component having a molecular weight of at least 500.

In a preferred embodiment, the ink according to the present invention additionally comprises a sorbitan ester emulsifier in its oil phase.

According to a second aspect of the present invention, a digital duplicating printing process comprises the application of a water-in-oil emulsion ink of the type described above to a substrate using a digital duplicator.

### DETAILED DESCRIPTION OF THE INVENTION

Inks according to the present invention are water-in-oil emulsions, comprising a water phase dispersed within an oil phase.

Water-in-oil inks according to the present invention comprise a polymeric emulsifier. This polymeric emulsifier comprises an ABA block copolymer comprising blocks of a polymer A and at least one block of a polymer B. One of the polymers (for example A) is derived from oil-soluble carboxylic acid monomers, and the other of the polymers (for example B) is water-soluble polyalkylene glycol. Typically, reaction of the oil-soluble carboxylic acid monomers with a water-soluble polyalkylene glycol results in a polymeric emulsifier which is a polyester-polyalkylene oxide-polyester. Preferably, the oil soluble mono-carboxylic acid monomers are 12-hydroxystearic acid and the water-soluble polyalkylene glycol is polyethylene oxide. This gives rise to a polymeric emulsifier which is a polyester-polyethylene oxide-polyester. Examples of such polymeric emulsifiers are available as Hypermer B246 and others from Uniqema (ICI Group of Companies).

The ABA block copolymers used in the present invention are described in more detail in U.S. Pat. No. 4,918,123, and a method for synthesising these copolymers is described in U.S. Pat. No. 4,203,877.

Inks according to the present invention may additionally comprise other emulsifying agents such as glycerol esters, glycol esters and lipids such as soya lecithin, which are usually also present in the oil phase.

In a preferred embodiment the ink comprises a blend of polymeric emulsifier and sorbitan ester emulsifier such as sorbitan mono-oleate. The preferred concentration of polymeric emulsifier in this blend falls within the range 8-80 wt %, more preferably 10-75 wt %. Typically the total weight of emulsifying agents within the ink lies within the range 2-8 wt %.

The oil phase comprises an oil or blend of oils. The oil may be a paraffinic or naphthenic mineral oil, a synthetic hydrocarbon such as polybutene, a hydrocarbon distillate, silicone oil, a vegetable oil such as rapeseed oil, soyabean or castor oil, or a vegetable oil ester such as soyabean butyl ester. The oils may be volatile or involatile. Typically the oil phase has a viscosity of less than 96 cP, and may have a viscosity of less than 90 cP or even less than 80 cP. Viscosity was measured at 21ΕC using a Brookfield DV-I viscometer with a no.2 spindle at 100 rpm.

The oil phase may optionally comprise a pigment or blend of pigments. Typically materials include but are not restricted to carbon black in such forms as lamp black, furnace black, channel black and acetylene black, metals and metal oxides such as iron, titanium dioxide and zinc sulphide, organic pigments such as azo, phthalocyanine, quinacridone and dioxazine types. Typically pigments will be present in the range 0.1 to 10%, more typically in the range 3-9%. Typically the pigments will be incorporated at a maximum particle size of 10 μm, more typically at a maximum particle size of 5 μm or less, preferably less than 2 μm and most preferably less than 1 μm.

The oil phase may also comprise an oil soluble resin, dispersing agents, extender fillers, waxes, gellants and antioxidants.

The water phase typically represents 50-85% of the total ink, more typically 60-80% of the total ink. The water phase also comprises additives known from prior art: stabilisers such as metal salts, water soluble resins, emulsion resins, fillers, waxes, chelating agents, antifreeze agents, pH adjusting agents, biocides, dispersing agents and the like.

The water phase may optionally comprise pigments of the type and typical concentration described for inclusion in the oil phase.

The emulsion ink is prepared by combining the water phase and the oil phase using mixing processes known from prior art.

The above described inks have improved storage stability and hence solve the problem of used stencils becoming stuck to the clamps of digital duplicating machines. Further, it has been found that there is an excellent correlation between the stability of emulsion inks to phase separation during storage and use, and the results of a centrifuge test. In more detail, for an ink to be suitably stable for storage and use, it is necessary for the ink to show minimal separation of oil when centrifuged, and it is preferable that less than 1%, more preferably less than 0.5% of the total ink weight separates in order to avoid the problems described.

### EXAMPLE 1

Furnace carbon black was added to a solution of polyvinyl pyrrolidone in water (30% of the total water in the ink) together with a non-ionic wetting agent. The mixture was stirred at high speed using a tooth wheel stirrer until it was homogenous with a maximum particle size of 1 μm. The dispersion was then milled in a Netzsch Minizeta horizontal bead mill containing zirconia grinding beads (0.4-0.7 mm) to achieve a dispersion where 90% of the particles (d₉₀) were less than 0.3 μm.

A water phase as shown in Table 1 was made by dissolving a polyacrylic acid resin (Junlon PW110; Nihon Junyaku Company) in water (70% of the total water in ink) and adding ammonia solution to achieve a pH of 6.8-7.2. To this gel was added the milled carbon dispersion, ethylene glycol and biocide solution.

An oil phase according to Table 1 was made by blending a low viscosity naphthenic oil (12-14 cSt at 40ΕC) with sorbitan mono-oleate and an ABA block copolymeric emulsifier (Hypermer B246; Uniqema) which has been warmed to 50ΕC to aid addition.

An emulsion ink was prepared by slow addition of the water phase to the oil phase which was stirred at high speed using a tooth wheel stirrer. Stirring was continued after addition of the water phase to ensure that the ink was homogeneous.

After standing overnight the ink stability to phase separation was measured by a centrifuge test using a Jouan model B4i centrifuge. A sample of ink of approximately 7 g (7.99-8.02 g) was accurately weighed into a weighed 10 ml centrifuge tube. The remaining tubes were filled with water to the same weight and accuracy to provide counterbalance. The ink sample was then centrifuged at 8200 rpm for 2.25 hours. Afterwards the tube was reweighed (W1) and inverted for a period of 3 hrs to let any separated clear oil drain from the tube to leave a black residue. Separated oil remaining on the inner surface of the tube was then removed by wiping the top 2 cm of the tube using a lintless cloth swab. The tube was then reweighed (W2) and the percentage oil separation was calculated by:

$$\frac{( W 1 - W 2 ) \times 100}{W 1 - Wtube}$$

For the ink of Example 1, the oil separation was 0.40%. Atty. Docket No. 043197.306583

### COMPARATIVE EXAMPLE

An ink was prepared by the method for Example 1 to incorporate the same total concentration of emulsifying agent (4% by weight) but where sorbitan mono-oleate was used in the absence of the Hypermer B246 ABA block copolymeric emulsifier.

In the centrifuge test, the oil separation was 1.2% confirming a significant risk of oil separation on the porous surface of the stencil master, with consequent problems resulting from the stencil becoming stuck to the clamp.

TABLE 1

| | | | COMPARATIVE |
|---|---|---|---|
| PHASE | COMPONENTS | EXAMPLE 1 | EXAMPLE |
| Oil Phase | Low Viscosity | 28 | 28 |
| | Naphthenic Oil | | |
| | ABA Block Copolymer | 1.2 | — |
| | Emulsifier | | |
| | Sorbitan Mono-oleate | 2.8 | 4.0 |
| Water | Water | 48.03 | 48.03 |
| Phase | Polyacrylic Acid | 0.13 | 0.13 |
| | 33% Ammonia | 0.05 | 0.05 |
| | Biocide Solution | 0.42 | 0.42 |
| | Ethylene Glycol | 7.00 | 7.00 |
| | Nonionic Surfactant | 1.67 | 1.67 |
| | Polyvinyl Pyrrolidone | 3.39 | 3.39 |
| | Furnace Carbon Black | 7.31 | 7.31 |
| | | 100 | 100 |

| | | |
|---|---|---|
| Oil | 0.42 | 1.20 |
| Separation | | |

1. A water-in-oil emulsion ink comprising a water phase dispersed within an oil phase, wherein the oil phase comprises a polymeric emulsifier, and wherein the polymeric emulsifier comprises an ABA block copolymer comprising blocks of a polymer A and at least one block of a polymer B, wherein one of polymer A or B is derived from one or more oil-soluble monocarboxylic acid monomers, and the other of polymer A or B is a water-soluble polyalkylene glycol.

2. An ink according to claim 1, wherein the one or more oil-soluble monocarboxylic acid monomers include 12-hydroxystearic acid and the water-soluble polyalkylene glycol is polyethylene oxide.

3. An ink according to claim 2, wherein the oil phase additionally comprises a sorbitan ester emulsifier.

4. An ink according to claim 3, wherein the sorbitan ester emulsifier is sorbitan mono-oleate.

5. An ink according to claim 1, wherein the oil phase additionally comprises a sorbitan ester emulsifier.

6. An ink according to claim 5, wherein the sorbitan ester emulsifier is sorbitan mono-oleate.

7. An ink according to claim 1, wherein the polymeric emulsifier comprises 8-80 wt % of the total amount of emulsifier in the ink.

8. An ink according to claim 1, wherein the viscosity of the oil phase is less than 96 cP.

9. An ink according to claim 1, wherein the water phase comprises a water-insoluble pigment.

10. A digital duplicating printing process comprising the application of a water-in-oil emulsion ink to a substrate using a digital duplicator, said ink comprising a water phase dispersed within an oil phase, wherein the oil phase comprises a polymeric emulsifier, and wherein the polymeric emulsifier comprises an ABA block copolymer comprising blocks of a polymer A and at least one block of a polymer B, wherein one of polymer A or B is derived from one or more oil-soluble monocarboxylic acid monomers, and the other of polymer A or B is a water-soluble polyalkylene glycol.

11. A process according to claim 10, wherein the one or more oil-soluble monocarboxylic acid monomers include 12-hydroxystearic acid and the water-soluble polyalkylene glycol is polyethylene oxide.

12. A process according to claim 11, wherein the oil phase additionally comprises a sorbitan ester emulsifier.

13. A process according to claim 12, wherein the sorbitan ester emulsifier is sorbitan mono-oleate.

14. A process according to claim 10, wherein the oil phase additionally comprises a sorbitan ester emulsifier.

15. A process according to claim 14, wherein the sorbitan ester emulsifier is sorbitan mono-oleate.

16. A process according to claim 10, wherein the polymeric emulsifier comprises 8-80 wt % of the total amount of emulsifier in the ink.

17. A process according to claim 10, wherein the viscosity of the oil phase is less than 96 cP.

18. A process according to claim 10, wherein the water phase comprises a water-insoluble pigment.
